(19) United States
(12) Patent Application Publication
(10) Pub. No.: US 2009/0087772 A1
(43) Pub. Date: Apr. 2, 2009

(54) DEVELOPER, IMAGE FORMING METHOD AND IMAGE FORMING APPARATUS

(75) Inventors: Hiroshi Kawaguchi, Kanagawa (JP); Shiho Moriya, Shizuoka (JP)

Correspondence Address: AMIN, TUROCY & CALVIN, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/236,562

(22) Filed: Sep. 24, 2008

Related U.S. Application Data
(60) Provisional application No. 60/976,151, filed on Sep. 28, 2007.
(60) Provisional application No. 60/976,167, filed on Sep. 28, 2007.

(51) Int. Cl. G03G 9/09; G03G 13/16; G03G 15/08

(52) U.S. Cl. 430/111.4; 430/125.3; 399/222

(57) ABSTRACT

A yellow toner, a magenta toner and a cyan toner, which are used for forming a color image, each contain a yellow pigment having an average dispersed diameter d_{y}, a magenta pigment having an average dispersed diameter dₘ and a cyan pigment having an average dispersed diameter d_{c}, respectively, and dₘ, d_{y} and d_{c} satisfy relationship dₘ>d_{y}>d_{c}.

### CROSS-REFERENCE TO RELATED APPLICATION

This application is based upon and claims the benefit of priority from the prior U.S. Patent Applications No. 60/976,151 filed on Sep. 28, 2007 and 60/976,167 filed on Sep. 28, 2007, the entire contents of which are incorporated herein by reference.

### TECHNICAL FIELD

The present invention relates to a developer, an image forming method and an image forming apparatus used for forming an image through an electrophotographic system, for example, with a duplicator and a printer.

### BACKGROUND

In an image forming apparatus using an electrophotographic system, in general, a toner is formed into a visual image on an electrostatic latent image carrying member, such as a photoreceptor, and then attached to a desired position on a transfer medium, such as paper. The toner attached to the transfer medium is fixed to the transfer medium by pressing with a heat roller or the like to form an image on the transfer medium.

In color electrophotography using toners of four colors including yellow, magenta, cyan and black, in recent years, there is a requirement of long-term storage stability of a color image. An image formed by color electrophotography suffers discoloration in yellow, magenta and cyan color parts due to exposure to an ultraviolet ray or the like upon long-term storage. The rates of discoloration are different from each other depending on colors. In general, magenta is discolored most rapidly among the three colors, and yellow and cyan are discolored at rates in this order. Upon discoloration of a color image, accordingly, the coloration balance is deteriorated to change the hue, such as secondary color, significantly.

For improving the light stability, for example, JP-A-2000-199982 discloses a method of optimizing species of pigments. However, the method has a problem of difficulty in formation of a satisfactory full color image.

### SUMMARY

The invention provides, according to one aspect, a developer containing a magenta pigment including a pigment having an average dispersed diameter dₘ satisfying 0.1≦dₘ≦1.0 (μm) and containing a Cl group and a quinacridone pigment.

The invention provides, according to another aspect, an image forming method including transferring toner images, which are formed with a yellow toner, a magenta toner, a cyan toner and a black toner on an image carrying member, sequentially onto a transfer medium to form an image, the yellow toner containing a yellow pigment having an average dispersed diameter d_{y} satisfying 0.05≦d_{y}≦0.50 (μm), a binder resin and a releasing agent, the magenta toner containing a magenta pigment having an average dispersed diameter dₘ satisfying 0.1≦dₘ≦1.0 (μm), a binder resin and a releasing agent, the cyan toner containing a cyan pigment having an average dispersed diameter d_{c} satisfying 0.03≦d_{c}≦0.3 (μm), a binder resin and a releasing agent, and dₘ, d_{y} and d_{c} satisfying relationship dₘ>d_{y}>d_{c}.

The invention provides, according to still another aspect, an image forming apparatus including an image carrying member, on which toner images formed with a yellow toner, a magenta toner, a cyan toner and a black toner are to be formed, the toner images formed with the toners on the image carrying member being transferred onto a transfer medium to form an image, the yellow toner containing a yellow pigment having an average dispersed diameter d_{y} satisfying 0.05≦d_{y}≦0.50 (μm), a binder resin and a releasing agent, the magenta toner containing a magenta pigment having an average dispersed diameter dₘ satisfying 0.1≦dₘ≦1.0 (μm), a binder resin and a releasing agent, the cyan toner containing a cyan pigment having an average dispersed diameter d_{c} satisfying 0.03≦d_{c}≦0.3 (μm), a binder resin and a releasing agent, and dₘ, d_{y} and d_{c} satisfying relationship dₘ>d_{y}>d_{c}.

It is to be understood that both the forgoing general description and the following detailed description are exemplary and explanatory only and are not restrictive of the invention, as claimed.

### DESCRIPTION OF THE DRAWINGS

The accompanying drawings, which is incorporated in and constitute a part of this specification, illustrates an embodiment of the invention and together with the description, serve to explain the principles of the invention.

FIG. 1A is a top view showing a measurement method of an average dispersed diameter of a pigment according to one embodiment of the invention;

FIG. 1B is a cross sectional view on line A-A′ in FIG. 1A;

FIG. 2 is a conceptual view showing an image forming apparatus by a four-tandem process according to an embodiment of the invention;

FIG. 3 is a conceptual view showing an image forming apparatus having an intermediate transfer medium by a four-tandem process according to an embodiment of the invention;

FIG. 4 is a table showing evaluation results of formulations-of toner particles of Examples according to embodiments of the invention and Comparative Examples; and

FIG. 5 is a table showing evaluation results of formulations of toner particles of Examples according to embodiments of the invention and Comparative Examples.

### DETAILED DESCRIPTION

Reference will now be made in detail to the present embodiment of the invention, an example of which is illustrated in the accompanying drawing.

A developer according to the embodiment contains a pigment having an average dispersed diameter dₘ satisfying 0.1≦dₘ≦1.0 (μm) and containing a Cl group, and a magenta pigment containing a quinacridone pigment.

An image forming method according to the embodiment contains transferring toner images, which are formed with a yellow toner, a magenta toner, a cyan toner and a black toner on an image carrying member, sequentially onto a transfer medium to form an image. The yellow toner contains a yellow pigment having an average dispersed diameter d_{y} satisfying 0.05≦d_{y}≦0.50 (μm), a binder resin and a releasing agent, the magenta toner contains a magenta pigment having an average dispersed diameter dₘ satisfying 0.1≦dₘ≦1.0 (μm), a binder resin and a releasing agent, and the cyan toner contains a cyan pigment having an average dispersed diameter d_{c} satisfying 0.03≦d_{c}≦0.3 (μm), a binder resin and a releasing agent. The average dispersed diameters dₘ, d_{y} and d_{c} satisfy the relationship dₘ>d_{y}>d_{c}.

An image forming apparatus according to the embodiment contains an image carrying member, on which toner images formed with a yellow toner, a magenta toner, a cyan toner and a black toner are to be formed, and the toner images formed with the toner particles on the image carrying member are transferred onto a transfer medium to form an image. The yellow toner contains a yellow pigment having an average dispersed diameter d_{y} satisfying 0.05≦d_{y}≦0.50 (μm), a binder resin and a releasing agent, the magenta toner contains a magenta pigment having an average dispersed diameter dₘ satisfying 0.1≦dₘ≦1.0 (μm), a binder resin and a releasing agent, and the cyan toner contains a cyan pigment having an average dispersed diameter d_{c} satisfying 0.03≦d_{c}≦0.3 (μm), a binder resin and a releasing agent. The average dispersed diameters dₘ, d_{y} and d_{c} satisfy the relationship dₘ>d_{y}>d_{c}.

In the embodiment, the particle diameters of the colorant particles, which tend to be decreased for enhancing dispersibility, are changed depending on the discoloration resistance thereof. In particular, a particle diameter of a magenta pigment, which has a high discoloration rate, is increased to suppress the discoloration rate.

The yellow toner used in the embodiment contains a yellow pigment as a colorant. The yellow pigment in the yellow toner necessarily has an average dispersed diameter d_{y} of from 0.05 to 0.50 μm. When the average dispersed diameter d_{y} is less than 0.05 μm, the discoloration rate is increased. When it exceeds 0.50 μm, the discoloration rate is decreased, but the variation in discoloration rate with respect to the other toners is increased. The average dispersed diameter d_{y} is more preferably from 0.1 to 0.3 μm.

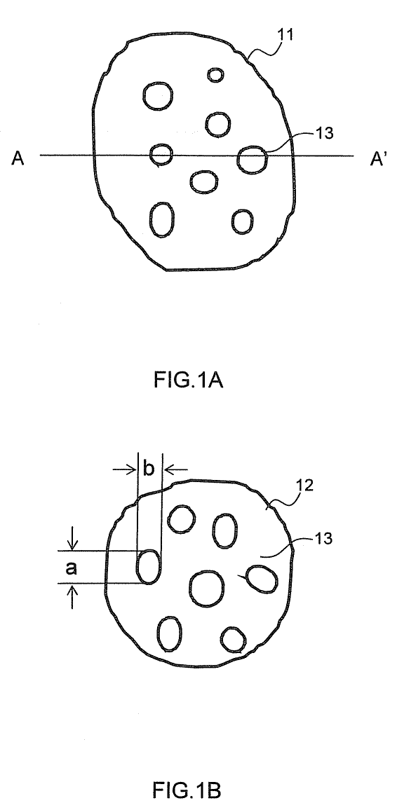

The average dispersed diameter can be obtained in the following method. FIG. 1A is a top view showing the measurement method, and FIG. 1B is a cross sectional view on line A-A′ in FIG. 1A. A slice surface 12 of a toner 11 is observed with a transmission electron microscope, and the major diameters a and the minor diameters b of the pigment particles 13 dispersed are measured. The particle diameters are each obtained as (((major diameter a)+(minor diameter b))/2), and an average value of the particle diameters is designated as the average dispersed diameter.

A monoazo pigment may be used as the yellow pigment. Preferred examples of the monoazo pigment include Pigment Yellow 74 (which is hereinafter abbreviated as PY 74). The yellow pigment preferably contains 70% by weight or more of PY 74 from the standpoint of reproducibility of red and green.

The magenta toner used in the embodiment contains a magenta pigment as a colorant. The magenta pigment in the magenta toner necessarily has an average dispersed diameter dₘ, which is obtained similarly to the yellow pigment, of from 0.1 to 1.0 μm, which is smaller than the conventional one, i.e., about 2 μm. When the average dispersed diameter dₘ is less than 0.1 μm, the discoloration rate is increased. When it exceeds 1.0 μm, the discoloration rate is decreased, but the variation in discoloration rate with respect to the other toners is increased. The average dispersed diameter dₘ is more preferably from 0.3 to 0.5 μm.

A pigment containing a Cl group, such as a naphthol pigment, and a quinacridone pigment may be used as the magenta pigment. In particular, incorporation of the naphthol pigment containing a Cl group enhances the discoloration resistance. Preferred examples of the quinacridone pigment include Pigment Red 122 (which is hereinafter abbreviated as PR 122). The content of the quinacridone pigment is preferably from 10 to 70% by weight based on the magenta pigment from the standpoint of reproducibility of blue.

The cyan toner used in the embodiment contains a cyan pigment as a colorant. The cyan pigment in the cyan toner necessarily has an average dispersed diameter d_{c}, which is obtained similarly to the yellow pigment, of from 0.03 to 0.3 μm. When the average dispersed diameter d_{c} is less than 0.03 μm, the discoloration rate is increased. When it exceeds 0.3 μm, the discoloration rate is decreased, but the variation in discoloration rate with respect to the other toners is increased. The average dispersed diameter d_{c} is more preferably from 0.05 to 0.1 μm.

A phthalocyanine pigment may be used as the cyan pigment. Preferred examples of the phthalocyanine pigment include Pigment Blue 15 (which is hereinafter abbreviated as PB 15). Specific examples thereof include PB 15:3, which is β-type copper phthalocyanine. The content of the phthalocyanine pigment is preferably 90% by weight or more based on the cyan pigment from the standpoint of reproducibility of blue.

The yellow toner, the magenta toner and the cyan toner are used in combination upon forming a color image, at which the average dispersed diameters dₘ, d_{y} and d_{c} necessarily satisfy the relationship dₘ>d_{y}>d_{c}. When the average dispersed diameters satisfy the relationship, the variation in discoloration rate among the pigments is suppressed, whereby change in hue, such as secondary color, can be suppressed even though the pigments of the colors are discolored upon long term storage.

Upon using the yellow toner, the magenta toner and the cyan toner in combination, it is preferred that the yellow pigment contains PY 74 in an amount of 70% by weight or more, the magenta pigment contains a pigment containing a Cl group and PR 122, and the cyan pigment contains PB 15 in an amount of 90% by weight or more. Accordingly, sufficient color reproducibility can be obtained.

Examples of a colorant used in the black toner, which is used in combination with the yellow toner, the magenta toner and the cyan toner, include carbon black. Specific examples thereof include acetylene black, furnace black, thermal black, channel black and Ketjen black.

The addition amounts of the colorants are each preferably from 3 to 10 parts by weight per 100 parts by weight of a binder resin described later. When the amount is less than 3 parts by weight, coloration power may be insufficient, and when it exceeds 10 parts by weight, filming on a photoreceptor tends to occur.

Preferred examples of the binder resin, which is contained in the yellow toner, the magenta toner, the cyan toner and the black toner, include a polyester resin. A copolymer resin, such as a styrene copolymer, an acrylic copolymer and a styrene-acrylic copolymer, produced by a copolymerization method, and a cyclic olefin resin may be used in combination.

Upon polymerizing a raw material monomer to produce the binder resin, a catalyst may be used for accelerating the reaction. Examples of the catalyst include those ordinarily used, such as dibutyltin oxide, a titanium compound, dialkoxytin(II), tin(II) oxide, a fatty acid ester of tin(II), tin(II) dioctanoate and tin (II) distearate.

The binder resin preferably has a haze value of 40 or less and a Gardner color scale of 7 or less. Accordingly, the binder resin has high transparency and color close to white, and thus coloration of the colorant itself can be exhibited without inhibition.

The binder resin preferably has a softening point (toner softening point) of from 105 to 115° C. Accordingly, favorable offset resistance can be obtained upon applying a low temperature fixing system having a temperature of a heat roller of from 130 to 180° C. to the image forming apparatus described later. Furthermore, the surface uniformity of the toner after fixing can be maintained, whereby diffuse reflection on the surface of the toner can be suppressed to exhibit coloration of the colorant itself without inhibition.

Examples of the releasing agent used in the embodiment include ester wax, for example, natural ester wax, such as carnauba wax and rice wax, and synthetic ester wax synthesized from a carboxylic acid and an alcohol.

The addition amount of the releasing agent is preferably from 3 to 8 parts by weight per 100 parts by weight of a binder resin. When the amount is less than 3 parts by weight, sufficient offset resistance may not be obtained, and when it exceeds 8 parts by weight, the releasing agent tends to be detached from the toner, and the developing property and the cleaning property may be deteriorated.

The releasing agent preferably has a haze value of 40 or less and a Gardner color scale of 11 or less. Accordingly, the releasing agent has high transparency and color close to white, and thus coloration of the colorant itself can be exhibited without inhibition.

The releasing agent preferably has an average dispersed diameter of from 0.04 to 4 μm. Accordingly, favorable offset resistance can be obtained upon applying a low temperature fixing system having a temperature of a heat roller of from 130 to 180° C. to the image forming apparatus described later. Furthermore, the surface uniformity of the toner after fixing can be maintained, whereby diffuse reflection on the surface of the toner can be suppressed to exhibit coloration of the colorant itself without inhibition. When the average dispersed diameter of the releasing agent is less than 0.04 μm, the offset resistance may be deteriorated. When it exceeds 4 μm, the releasing agent tends to be detached from the toner, and the developing property and the cleaning property may be deteriorated. The average dispersed diameter of the releasing agent is more preferably from 0.1 to 1.0 μm.

In the embodiment, a charge controlling agent for controlling the frictional charge amount maybe contained. Examples of the charge controlling agent include a metal-containing azo compound. The metal-containing azo compound is preferably a complex compound or complex salt containing iron, cobalt or chromium as a metallic element, or a mixture thereof. Examples of the charge controlling agent also include a metal-containing salicylic acid derivative and a hydrophobic treated product of a metallic oxide. The metal-containing salicylic acid derivative and the hydrophobic treated product of a metallic oxide is preferably a complex compound or complex salt containing zirconium, zinc, chromium, aluminum, magnesium or boron as a metallic element, or a mixture thereof.

In the embodiment, an external additive is preferably added to the toner surface for stabilizing the fluidity, the charging property and the storage stability of the toner.

Examples of the external additive include fine particles of an inorganic compound, and preferred examples thereof include inorganic oxides, such as silica, titania, alumina, strontium titanate and tin oxide. The fine particles of an inorganic compound are preferably surface-treated with a hydrophobic agent from the standpoint of enhancement in environmental stability. In addition to the inorganic compound, fine particles of a resin or fine particles of a metallic soap as a drum cleaner lubricant may be added.

The particle diameters of the pigments contained in the yellow toner, the magenta toner and the cyan toner, and the relationship in magnitude thereof is defined, whereby discoloration upon long term storage can be suppressed, and the variation in discoloration rate among the toners can be suppressed to decrease the change in hue, such as secondary color.

The toners may be produced by a known method, such as a pulverizing method or a chemical method, such as a polymerization method. In the pulverizing method, the raw materials including the binder resin, the releasing agent and the colorant are mixed and kneaded in a molten state. The kneaded product of the raw materials is pulverized and classified, and an external additive is added thereto to form the toners.

Examples of an apparatus for mixing and dispersing the raw materials include a mixer and a kneader. Examples of the mixer include Henschel Mixer (produced by Mitsui Mining Co., Ltd.), Super Mixer (produced by Kawata MFG Co., Ltd.), Ribocorn (produced by Okawara Corporation), Nauta Mixer, Tervurizer and Cyclomix (produced by Hosokawa Micron Co., Ltd.), Spiralpin Mixer (produced by Pacific Machinery & Engineering Co., Ltd.) and Lödige Mixer (produced by Matsubo Corporation). Mixers such as these can be used when an external additive is added.

Examples of the kneader include KRC Kneader (produced by Kurimoto, Ltd.), Buss Co-kneader (produced by Buss AG), Extruder Type TME (produced by Toshiba Machine Co., Ltd.), TEX Biaxial Kneader (produced by Japan Steel Works, Ltd.), PCM Kneader (produced by Ikegai Corporation), Three-roll Mill, Mixing Roll Mill and Kneader (produced by Inoue Manufacturing Co., Ltd.), Kneadex (produced by Mitsui Mining Co., Ltd.), MS-type Pressure Kneader and Kneader-Ruder (produced by Moriyama Co., Ltd.) and Banbury Mixer (produced by Kobe Steel Co., Ltd.).

Examples of an apparatus for coarsely pulverizing the mixed product include a hammer mill, a cutter mill, a jet mill, a roller mill and a ball mill. Examples of an apparatus for finely pulverizing the coarsely pulverized product include a pulverizer. Examples of the pulverizer include Counter Jet Mill, Micronjet and Inomizer (produced by Hosokawa Micron Co., Ltd.), IDS-type Mill and PJM Jet Pulverizer (produced by Nippon Pneumatic Mfg. Co., Ltd.), Crossjet Mill (produced by Kurimoto, Ltd.), Ulmax (produced by Nisso Engineering Co., Ltd.), SK Jet-O-Mill (produced by Seishin Enterprise Co., Ltd.), Kryptron (produced by Kawasaki Heavy Industries, Ltd.) and Turbo Mill (produced by Turbo Kogyo Co., Ltd.).

Examples of the classifier for classifying the finely pulverized product include Classiel, Micron Classifier and Spedic Classifier (produced by Seishin Enterprise Co., Ltd.), Turbo Classifier (produced by Nisshin Engineering Inc.), Micron Separator, Turboplex ATP and TSP Separator (produced by Hosokawa Micron Co., Ltd.), Elbow-Jet (produced by Nittetsu Mining Co., Ltd.), Dispersion Separator (produced by Nippon Pneumatic Mfg. Co., Ltd.) and YM Microcut (produced by Yasukawa Shoji Co., Ltd.). Examples of a sieve apparatus for sieving coarse particles or the like include Ultrasonic (produced by Koei Sangyo Co., Ltd.), Resona Sieve and Gyro Sifter (produced by Tokuju Corporation), Vibrasonic System (produced by Dalton Corporation), Sonicreen (produced by Sintokogyo, Ltd.), Turbo Screener (produced by Turbo Kogyo Co., Ltd.) and Microshifter (produced by Makino MFG Co., Ltd.) and a circular vibration sieve.

Upon forming the toners by using the apparatuses, the particle diameters of the pigments can be controlled by the mixing time upon mixing and the conditions for kneading. For example, the particle diameters can be controlled by the mixing time with a Henschel Mixer, and the conditions for forming a master batch with a three-roll kneader and for kneading with an extrusion melt kneading machine (such as the rotation numbers of the axes, the rate of charging the raw materials and the structure of the axes).

In the polymerization method, a pigment having a prescribed particle diameter and a mixture containing a binder resin and the like are formed into coarse particles, which are mixed with an aqueous medium to form a mixture, and the mixture is mechanically sheared to form fine particles, which are then aggregated to form the toner particles. The aggregated particles may be further fused depending on necessity in the process.

The toners may each be used as a one-component developer as it is or may be used as a two-component developer by adding a magnetic carrier thereto. Examples of the magnetic carrier include magnetic particles of ferrite, magnetite, iron oxide or the like, resin particles containing the magnetic particles, and particles containing the magnetic particles having on at least a part of the surface thereof a resin coating, such as a fluorine resin, a silicone resin and an acrylic resin.

The magnetic carrier particle preferably has a volume average particle diameter of from 20 to 100 μm. When the particle diameter is less than 20 μm, the carrier particles are liable to be detached from a developer carrying member and attached to a photoreceptor due to a small magnetic force per one particle, and when it exceeds 100 μm, the magnetic brush formed may become too hard, whereby brush lines thereof may appear in an image formed, and the toner may be difficult to feed precisely. The volume average particle diameter of the magnetic carrier is more preferably from 30 to 60 μm.

The toners each preferably have a volume average radius r of from 1.5 to 4 μm. When the volume average radius is less than 1.5 μm, the charge amount per weight may become too large upon applying a charge amount that can be controlled with the electric field to the toners, whereby an intended developed amount may not be obtained. When it exceeds 4 μm, a fine image may be deteriorated in reproducibility and granularity. The volume average radius is more preferably from 2 to 3 μm.

The yellow toner, the magenta toner, the cyan toner and the black toner formed are each combined with the magnetic carrier depending on necessity to constitute a developer kit.

Examples of an image carrying member (electrostatic latent image carrying member) used in an image forming method and an image forming apparatus for forming an image with the toners on a transfer medium include a known photoreceptor, such as a positively charging or negatively charging OPC (organic photoconductor) and amorphous silicon. In the photoreceptor, a charge generating layer, a charge transporting layer and a protective layer may be laminated, and a layer having functions of plural layers among the layers may be laminated. The transfer medium is a medium, on which an image is finally formed, such as paper.

An image can be formed, for example, through the following electrophotographic process using the image forming method or the image forming apparatus.

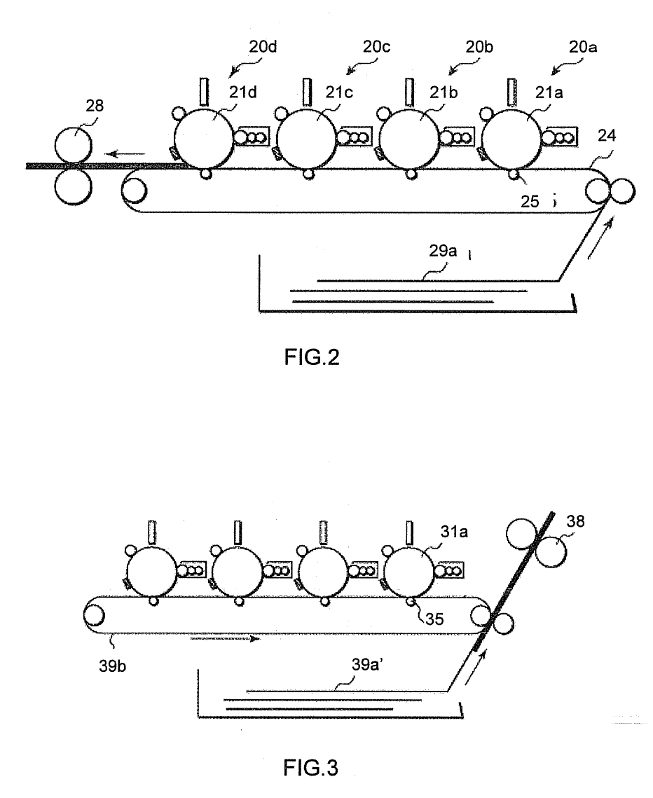

FIG. 2 is a conceptual view showing an image forming apparatus by a four-tandem process. As shown in the figure, image forming units 20a, 20b, 20c and 20d, each of which contains a developing device containing the yellow, magenta, cyan or black toner, a photoreceptor and charging, exposing and transferring devices, are provided for the four colors, and disposed in series along the transporting path of a transfer medium 29a. A fixing device 28 constituted by a heat roller and a press roller for fixing a toner image on paper is disposed. An image is formed through the following process by using the image forming apparatus. Herein, an example will be described, in which the image forming units for yellow, magenta, cyan and black are arranged in this order.

In the yellow image forming unit, a yellow toner image is formed on the photoreceptor 21a and transferred to the transfer medium 29a. In the case of a direct transferring system, paper or the like as the final transfer medium is transported with a transporting member, such as a transfer belt or roller, and fed to the transferring area of the yellow image forming unit. FIG. 2 shows such a constitution that an image is transferred with a transfer roller 25 onto paper transported with a transfer belt 24 as the transporting member. Examples of the transferring system include a known transferring system, such as a transfer roller, a transfer blade and a corona charger.

At the transferring position, the transfer belt 24 in contact with the photoreceptor 21a is pressed onto the photoreceptor 21a with a transfer roller 25, and a transfer bias voltage having a prescribed magnitude and a prescribed polarity is applied with a transfer bias power source between the transfer roller 25 and the transfer medium 29a disposed between the transfer belt 24 and the photoreceptor 21a. The application of the transfer bias voltage transfers the toner image (toner) electrostatically attached to the outer surface of the photoreceptor 21a onto the transfer medium 29a through attraction toward the transfer medium 29a.

An intermediate transfer belt 39a may be provided as an intermediate medium as shown in FIG. 3. The intermediate transfer belt 39b may be a semiconductive member having a thickness of from 50 to 3,000 μm constituted by a resin, rubber or a laminated member thereof, and a transfer roller 35 (transferring device) is in contact with the backside of the belt on the opposite side to the photoreceptor 31a. A prescribed transfer bias voltage is applied to the transfer roller 35 from a transfer bias voltage power source, whereby a transfer electric field is formed at and around a transfer nip part where the photoreceptor 31a and the intermediate transfer belt 39a are in contact with each other.

In the embodiment, a transfer roller 35 using semiconductive sponge having a volume resistivity of from 10⁵ to 10⁹ Ω·cm is made in contact with the backside of the belt, and a direct current voltage of from 300 to 3,000 V is applied to the transfer roller 35, whereby a toner image on the photoreceptor of the processing unit is transferred onto the intermediate transfer belt 39a. Four process units having the similar structure are arranged and transfer the images overlapped to form a full color image. Thereafter, the image is transferred onto a transfer medium 49a′, such as paper, at the secondarily transferring position and then fixed by heating with a fixing device 38 to form a final image.

The intermediate transfer belt may have the same constitution in material and structure as the transfer belt 24. The surface resistance of the intermediate transfer belt is preferably from 10⁷ to 10¹² Ω·cm, and is, for example, 10⁹ Ω·cm.

In the magenta image forming unit 20b, a magenta toner image is formed on the photoreceptor 21b. The transfer medium 29a having the yellow toner image transferred thereon is fed to the transferring area of the magenta image forming unit 20b, and the magenta toner image is transferred onto the yellow toner image by positioning. The yellow toner on the transfer medium thus transported may sometimes be reversely transferred to the magenta photoreceptor 21b through contact with the magenta photoreceptor 21b depending on the magnitudes of the toner charge amount and the transfer electric field.

In the cyan and black image forming units 20c and 20d, toner images are similarly formed and transferred sequentially onto the transfer medium 29b by overlapping. To the cyan and black photoreceptors 21c and 21d, the toners of the preceding steps may sometimes be reversely transferred, respectively.

The transfer medium 29a having the toner images of four colors transferred thereon is fed to the fixing device 28, and the images are fixed by a known heat-pressure fixing system using a heat roller or the like. In the case using the intermediate transfer medium 39b (FIG. 3), the toner images of four colors are transferred at one time with the secondarily transferring device onto the final transfer medium 39a′, such as paper, which is then fed to the fixing device 38 for fixing the images.

In the fixing devices 28 and 38, such a fixing system may be used that has a heat roller temperature of from 130 to 180° C. and a nip width between a heat roller and a press roller of from 13 to 16 mm. The fixing system can maintain favorable offset resistance. The transfer media 29a and 39a′ having the toner image fixed thereon are then discharged outside the apparatus.

In the image forming units, the photoreceptors 31a, 31b, 31c and 31d are destaticized, and the toner remaining after transferring and the reversely transferred toner are removed by a cleaning process. The photoreceptors then return to the image forming process. In the developing device, the relative concentrations of the toners are adjusted.

While the embodiment shows an example where the image forming units for yellow, magenta, cyan and black are arranged in this order, the order of the colors is not limited thereto.

The embodiment will be described specifically with reference to examples.

### EXAMPLE 1

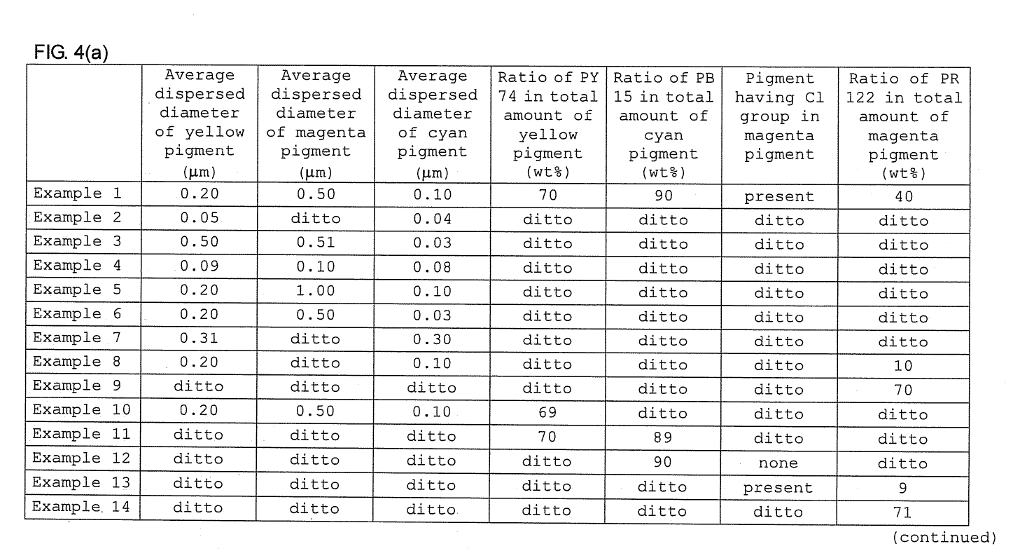

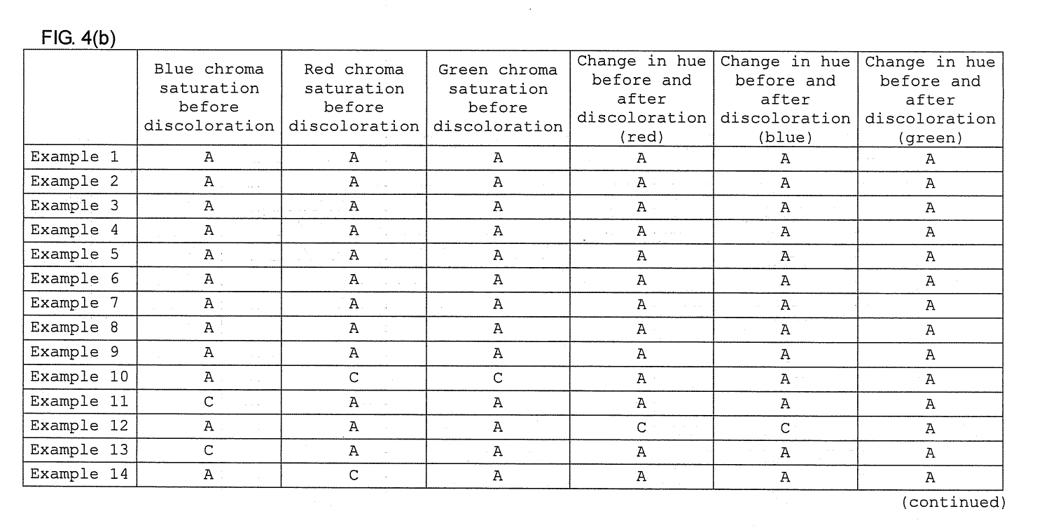

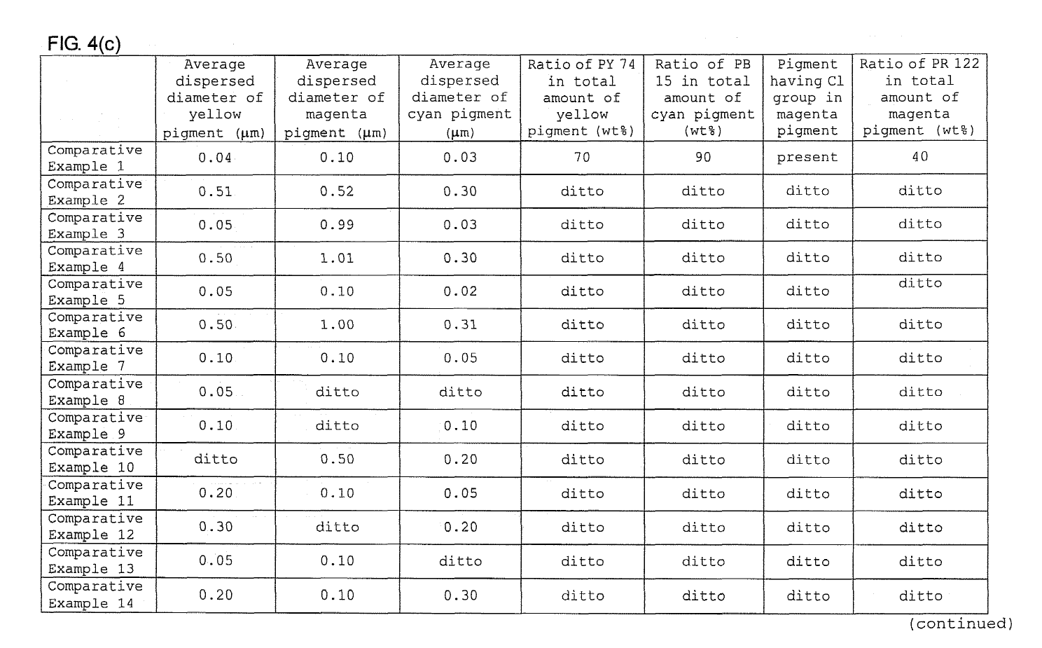

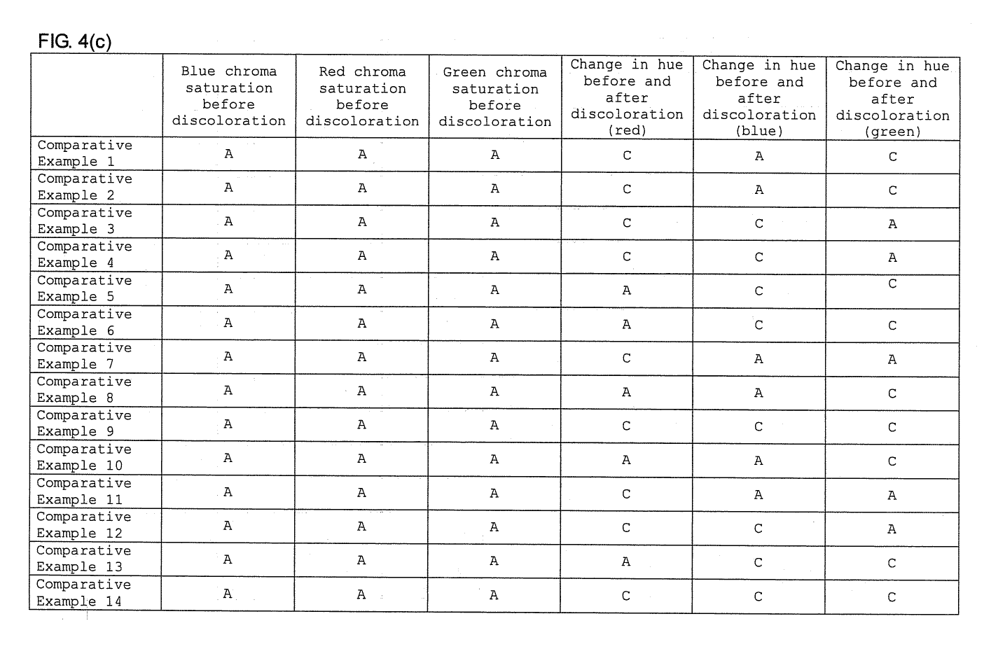

A polyester resin as a binder resin was mixed with carnauba wax as a releasing agent in an amount of 4% by weight, a charge controlling agent in an amount of 1.5% by weight and toners having the average dispersed diameters and the formulations shown in FIG. 4 in a total amount of 6% by weight for the yellow and magenta toners and 4% by weight for the cyan toner, all based on the weight of the toner as 100% by weight, and mixed with a Henschel mixer. After kneading with an extrusion melt-kneading machine, the mixtures were pulverized and classified to provide core toners. The core toners were each mixed with titanium oxide having a primary particle diameter of 15 nm in an amount of 0.5%, silica having a primary particle diameter of 20 nm in an amount of 1% and a metallic soap as a drum cleaner lubricant in an amount of 0.1% as external additives, and mixed with a Henschel mixer for a prescribed period of time to provide toners.

The toners were each mixed with a carrier to a toner content of 7% by weight to provide developers, with which images were formed under the following conditions by using a multifunction printer e-STUDIO 3500C, produced by Toshiba Corporation, as an image forming apparatus. The images thus output were evaluated in the following manners. The chromatic coordinate was measured with a calorimeter, produced by X-Rite GmbH.

### Evaluation of Blue Chroma Saturation Before Discoloration

The amounts of the magenta toner and the cyan toner on the photoreceptor were adjusted to 0.5 mg/cm by controlling the developing voltages, and an image having two colors overlapping was output. The chromatic coordinate thereof was measured. A square root of a sum of a* and b* of 47 or more was evaluated as A (good), and that of less than 47 was evaluated as C (poor).

### Evaluation of Red Chroma Saturation Before Discoloration

The amounts of the magenta toner and the yellow toner were adjusted by controlling the developing voltages as similar to the evaluation of the blue chroma saturation before discoloration, and an image having two colors overlapping was output. The chromatic coordinate thereof was measured. A square root of a sum of a* and b* of 79 or more was evaluated as A (good), and that of less than 79 was evaluated as C (poor).

### Evaluation of Green Chroma Saturation Before Discoloration

The amounts of the yellow toner and the cyan toner were adjusted by controlling the developing voltages as similar to the evaluation of the blue chroma saturation before discoloration, and an image having two colors overlapping was output. The chromatic coordinate thereof was measured. A square root of a sum of a* and b* of 63 or more was evaluated as A (good), and that of less than 63 was evaluated as C (poor).

### Evaluation of Change in Hue Before and After Discoloration (Red)

The amounts of the yellow toner and the magenta toner were adjusted by controlling the developing voltages as similar to the evaluation of the blue chroma saturation before discoloration, and an image R having two colors overlapping was output. The chromatic coordinate thereof was measured, and b*/a* (before discoloration) was obtained.

The image R was subjected to a discoloration test by 50-hour continuous irradiation with a light resistance tester (with xenon lamp, C Suntest CPS+, produced by Atlas Material Testing Technology Corporation) under conditions of 550 W/m² and 35° C. with a filter containing a quartz filter (having infrared reflection coating) and a window glass filter. b*′/a*′ after discoloration was obtained as similar to b*/a* before discoloration. An absolute value of a difference between b*/a* and b*′/a*′ of less than 0.2 was evaluated as A (good), and that of 0.2 or more was evaluated as C (poor).

### Evaluation of Change in Hue Before and After Discoloration (Blue)

The amounts of the magenta toner and the cyan toner were adjusted by controlling the developing voltages as similar to the evaluation of the blue chroma saturation before discoloration, and an image B having two colors overlapping was output. The chromatic coordinate thereof was measured, and b*/a* (before discoloration) was obtained.

The image B was subjected to the discoloration test as similar to the evaluation of change in hue before and after discoloration (red). b*′/a*′ after discoloration was obtained as similar to b*/a* before discoloration. An absolute value of a difference between b*/a* and b*′/a*′ of less than 0.1 was evaluated as A (good), and that of 0.1 or more was evaluated as C (poor).

### Evaluation of Change in Hue Before and After Discoloration (Green)

The amounts of the yellow toner and the cyan toner were adjusted by controlling the developing voltages as similar to the evaluation of the blue chroma saturation before discoloration, and an image G having two colors overlapping was output. The chromatic coordinate thereof was measured, and b*/a* (before discoloration) was obtained.

The image G was subjected to the discoloration test as similar to the evaluation of change in hue before and after discoloration (red). b*′/a*′ after discoloration was obtained as similar to b*/a* before discoloration. An absolute value of a difference between b*/a* and b*′/a*′ of less than 0.1 was evaluated as A (good), and that of 0.1 or more was evaluated as C (poor).

The evaluation results are also shown in FIG. 4. As shown in FIG. 4, in Example 1, the average dispersed diameters of the pigments in the toners were in the prescribed ranges, and the order of the relationship in magnitude thereof was in the prescribed order. The ratio of PY 74 in the yellow pigment, the ratio of PB 15 in the cyan pigment and the ratios of PR 122 and the pigment containing a Cl group in the magenta pigment were in the suitable ranges. Satisfactory characteristics were obtained in all the evaluations.

### EXAMPLE 2

The pigments were mixed at the average dispersed diameters and the formulations shown in FIG. 4. The average dispersed diameter of the yellow pigment was set at the lower limit of the prescribed range, and the order of the relationship in magnitude of the average dispersed diameters of the pigments was in the prescribed order. The ratio of PY 74 in the yellow pigment, the ratio of PB 15 in the cyan pigment and the ratios of PR 122 and the pigment containing a Cl group in the magenta pigment were in the suitable ranges. The toners were produced in the same manner as in Example 1 and evaluated in the same manner as in Example 1. Satisfactory characteristics were obtained in all the evaluations.

### EXAMPLE 3

The pigments were mixed at the average dispersed diameters and the formulations shown in FIG. 4. The average dispersed diameter of the yellow pigment was set at the upper limit of the prescribed range, and the order of the relationship in magnitude of the average dispersed diameters of the pigments was in the prescribed order. The ratio of PY 74 in the yellow pigment, the ratio of PB 15 in the cyan pigment and the ratios of PR 122 and the pigment containing a Cl group in the magenta pigment were in the suitable ranges. The toners were produced in the same manner as in Example 1 and evaluated in the same manner as in Example 1. Satisfactory characteristics were obtained in all the evaluations.

### EXAMPLE 4

The pigments were mixed at the average dispersed diameters and the formulations shown in FIG. 4. The average dispersed diameter of the magenta pigment was set at the lower limit of the prescribed range, and the order of the relationship in magnitude of the average dispersed diameters of the pigments was in the prescribed order. The ratio of PY 74 in the yellow pigment, the ratio of PB 15 in the cyan pigment and the ratios of PR 122 and the pigment containing a Cl group in the magenta pigment were in the suitable ranges. The toners were produced in the same manner as in Example 1 and evaluated in the same manner as in Example 1. Satisfactory characteristics were obtained in all the evaluations.

### EXAMPLE 5

The pigments were mixed at the average dispersed diameters and the formulations shown in FIG. 4. The average dispersed diameter of the magenta pigment was set at the upper limit of the prescribed range, and the order of the relationship in magnitude of the average dispersed diameters of the pigments was in the prescribed order. The ratio of PY 74 in the yellow pigment, the ratio of PB 15 in the cyan pigment and the ratios of PR 122 and the pigment containing a Cl group in the magenta pigment were in the suitable ranges. The toners were produced in the same manner as in Example 1 and evaluated in the same manner as in Example 1. Satisfactory characteristics were obtained in all the evaluations.

### EXAMPLE 6

The pigments were mixed at the average dispersed diameters and the formulations shown in FIG. 4. The average dispersed diameter of the cyan pigment was set at the lower limit of the prescribed range, and the order of the relationship in magnitude of the average dispersed diameters of the pigments was in the prescribed order. The ratio of PY 74 in the yellow pigment, the ratio of PB 15 in the cyan pigment and the ratios of PR 122 and the pigment containing a Cl group in the magenta pigment were in the suitable ranges. The toners were produced in the same manner as in Example 1 and evaluated in the same manner as in Example 1. Satisfactory characteristics were obtained in all the evaluations.

### EXAMPLE 7

The pigments were mixed at the average dispersed diameters and the formulations shown in FIG. 4. The average dispersed diameter of the cyan pigment was set at the upper limit of the prescribed range, and the order of the relationship in magnitude of the average dispersed diameters of the pigments was in the prescribed order. The ratio of PY 74 in the yellow pigment, the ratio of PB 15 in the cyan pigment and the ratios of PR 122 and the pigment containing a Cl group in the magenta pigment were in the suitable ranges. The toners were produced in the same manner as in Example 1 and evaluated in the same manner as in Example 1. Satisfactory characteristics were obtained in all the evaluations.

### EXAMPLE 8

The pigments were mixed at the average dispersed diameters and the formulations shown in FIG. 4. The content ratio of PR 122 in the magenta pigment was set at the lower limit of the prescribed range, and the order of the relationship in magnitude of the average dispersed diameters of the pigments was in the prescribed order. The ratio of PY 74 in the yellow pigment, the ratio of PB 15 in the cyan pigment and the ratios of PR 122 and the pigment containing a Cl group in the magenta pigment were in the suitable ranges. The toners were produced in the same manner as in Example 1 and evaluated in the same manner as in Example 1. Satisfactory characteristics were obtained in all the evaluations.

### EXAMPLE 9

The pigments were mixed at the average dispersed diameters and the formulations shown in FIG. 4. The content ratio of PR 122 in the magenta pigment was set at the upper limit of the prescribed range, and the order of the relationship in magnitude of the average dispersed diameters of the pigments was in the prescribed order. The ratio of PY 74 in the yellow pigment, the ratio of PB 15 in the cyan pigment and the ratios of PR 122 and the pigment containing a Cl group in the magenta pigment were in the suitable ranges. The toners were produced in the same manner as in Example 1 and evaluated in the same manner as in Example 1. Satisfactory characteristics were obtained in all the evaluations.

### EXAMPLE 10

The pigments were mixed at the average dispersed diameters and the formulations shown in FIG. 4. The average dispersed diameters of the yellow pigment, the magenta pigment and the cyan pigment were in the prescribed ranges and the order of the relationship in magnitude of the average dispersed diameters of the pigments was in the prescribed order, but the ratio of PY 74 in the yellow pigment was smaller than the suitable range. The toners were produced in the same manner as in Example 1 and evaluated in the same manner as in Example 1. The change in hue of red, blue and green before and after discoloration was suppressed while the chroma saturation of red and green before discoloration was not satisfactory.

### EXAMPLE 11

The pigments were mixed at the average dispersed diameters and the formulations shown in FIG. 4. The average dispersed diameters of the yellow pigment, the magenta pigment and the cyan pigment were in the prescribed ranges and the order of the relationship in magnitude of the average dispersed diameters of the pigments was in the prescribed order, but the ratio of PB 15 in the cyan pigment was smaller than the suitable range. The toners were produced in the same manner as in Example 1 and evaluated in the same manner as in Example 1. The change in hue of red, blue and green before and after discoloration was suppressed while the chroma saturation of blue before discoloration was not satisfactory.

### EXAMPLE 12

The pigments were mixed at the average dispersed diameters and the formulations shown in FIG. 4. The average dispersed diameters of the yellow pigment, the magenta pigment and the cyan pigment were in the prescribed ranges and the order of the relationship in magnitude of the average dispersed diameters of the pigments was in the prescribed order. A pigment containing no Cl group was used as the magenta pigment other than PR 122. The toners were produced in the same manner as in Example 1 and evaluated in the same manner as in Example 1. The chroma saturation was good before discoloration, and the change in hue of red and blue was not satisfactory but was improved as compared to a conventional one using pigments having the same average dispersed diameter.

### EXAMPLE 13

The pigments were mixed at the average dispersed diameters and the formulations shown in FIG. 4. The average dispersed diameters of the yellow pigment, the magenta pigment and the cyan pigment were in the prescribed ranges and the order of the relationship in magnitude of the average dispersed diameters of the pigments was in the prescribed order, but the ratio of PR 122 in the magenta pigment was smaller than the suitable range. The toners were produced in the same manner as in Example 1 and evaluated in the same manner as in Example 1. The change in hue of red, blue and green before and after discoloration was suppressed while the hue of magenta was reddish, and the chroma saturation of blue before discoloration was not satisfactory.

### EXAMPLE 14

The pigments were mixed at the average dispersed diameters and the formulations shown in FIG. 4. The average dispersed diameters of the yellow pigment, the magenta pigment and the cyan pigment were in the prescribed ranges and the order of the relationship in magnitude of the average dispersed diameters of the pigments were in the prescribed order, but the ratio of PR 122 in the magenta pigment was larger than the suitable range. The toners were produced in the same manner as in Example 1 and evaluated in the same manner as in Example 1. The change in hue of red, blue and green before and after discoloration was suppressed while the hue of magenta was bluish, and the chroma saturation of red before discoloration was not satisfactory.

### COMPARATIVE EXAMPLE 1

The pigments were mixed at the average dispersed diameters and the formulations shown in FIG. 4. The average dispersed diameter of the yellow pigment was set smaller than the prescribed range. The toners were produced in the same manner as in Example 1 and evaluated in the same manner as in Example 1. While the chroma saturation before discoloration was good for the three colors, the discoloration rate of yellow was larger than those of magenta and cyan, and the change in hue of red and green before and after discoloration was large.

### COMPARATIVE EXAMPLE 2

The pigments were mixed at the average dispersed diameters and the formulations shown in FIG. 4. The average dispersed diameter of the yellow pigment was set larger than the prescribed range. The toners were produced in the same manner as in Example 1 and evaluated in the same manner as in Example 1. While the chroma saturation before discoloration was good for the three colors, the discoloration rate of yellow was smaller than those of magenta and cyan, and the change in hue of red and green before and after discoloration was large.

### COMPARATIVE EXAMPLE 3

The pigments were mixed at the average dispersed diameters and the formulations shown in FIG. 4. The average dispersed diameter of the magenta pigment was set smaller than the prescribed range. The toners were produced in the same manner as in Example 1 and evaluated in the same manner as in Example 1. While the chroma saturation before discoloration was good for the three colors, the discoloration rate of magenta was larger than those of yellow and cyan, and the change in hue of red and blue before and after discoloration was large.

### COMPARATIVE EXAMPLE 4

The pigments were mixed at the average dispersed diameters and the formulations shown in FIG. 4. The average dispersed diameter of the magenta pigment was set larger than the prescribed range. The toners were produced in the same manner as in Example 1 and evaluated in the same manner as in Example 1. While the chroma saturation before discoloration was good for the three colors, the discoloration rate of magenta was smaller than those of yellow and cyan, and the change in hue of red and blue before and after discoloration was large.

### COMPARATIVE EXAMPLE 5

The pigments were mixed at the average dispersed diameters and the formulations shown in FIG. 4. The average dispersed diameter of the cyan pigment was set smaller than the prescribed range. The toners were produced in the same manner as in Example 1 and evaluated in the same manner as in Example 1. While the chroma saturation before discoloration was good for the three colors, the discoloration rate of cyan was larger than those of yellow and magenta, and the change in hue of blue and green before and after discoloration was large.

### COMPARATIVE EXAMPLE 6

The pigments were mixed at the average dispersed diameters and the formulations shown in FIG. 4. The average dispersed diameter of the cyan pigment was set larger than the prescribed range. The toners were produced in the same manner as in Example 1 and evaluated in the same manner as in Example 1. While the chroma saturation before discoloration was good for the three colors, the discoloration rate of cyan was smaller than those of yellow and magenta, and the change in hue of blue and green before and after discoloration was large.

### COMPARATIVE EXAMPLE 7

The pigments were mixed at the average dispersed diameters and the formulations shown in FIG. 4. The order of the relationship in magnitude of the average dispersed diameters of the yellow pigment and the magenta pigment was set opposite order to the prescribed order. The toners were produced in the same manner as in Example 1 and evaluated in the same manner as in Example 1. While the chroma saturation before discoloration was good for the three colors, the discoloration rate of magenta was larger than that of yellow, and the change in hue of red before and after discoloration was large.

### COMPARATIVE EXAMPLE 8

The pigments were mixed at the average dispersed diameters and the formulations shown in FIG. 4. The average dispersed diameters of the yellow pigment and the cyan pigment were set equal to each other. The toners were produced in the same manner as in Example 1 and evaluated in the same manner as in Example 1. While the chroma saturation before discoloration was good for the three colors, the discoloration rate of yellow was larger than that of cyan, and the change in hue of green before and after discoloration was large.

### COMPARATIVE EXAMPLE 9

The pigments were mixed at the average dispersed diameters and the formulations shown in FIG. 4. The average dispersed diameters of the yellow pigment, the magenta pigment and the cyan pigment were set equal to each other. The toners were produced in the same manner as in Example 1 and evaluated in the same manner as in Example 1. While the chroma saturation before discoloration was good for the three colors, the order of the relationship of the discoloration rates was magenta>yellow>cyan, and the change in hue of red, blue and green before and after discoloration was large.

### COMPARATIVE EXAMPLE 10

The pigments were mixed at the average dispersed diameters and the formulations shown in FIG. 4. The order of the relationship in magnitude of the average dispersed diameters of the yellow pigment and the cyan pigment was set opposite order to the prescribed order. The toners were produced in the same manner as in Example 1 and evaluated in the same manner as in Example 1. While the chroma saturation before discoloration was good for the three colors, the discoloration rate of yellow was larger than that of cyan, and the change in hue of green before and after discoloration was large.

### COMPARATIVE EXAMPLE 11

The pigments were mixed at the average dispersed diameters and the formulations shown in FIG. 4. The order of the relationship in magnitude of the average dispersed diameters of the yellow pigment and the magenta pigment was set opposite order to the prescribed order. The toners were produced in the same manner as in Example 1 and evaluated in the same manner as in Example 1. While the chroma saturation before discoloration was good for the three colors, the discoloration rate of magenta was larger than that of yellow, and the change in hue of red before and after discoloration was large.

### COMPARATIVE EXAMPLE 12

The pigments were mixed at the average dispersed diameters and the formulations shown in FIG. 4. The order of the relationship in magnitude of the average dispersed diameters of the yellow pigment, the magenta pigment and the cyan pigment was set different order from the prescribed order. The toners were produced in the same manner as in Example 1 and evaluated in the same manner as in Example 1. While the chroma saturation before discoloration was good for the three colors, the discoloration rate of magenta was larger than those of yellow and cyan, and the change in hue of red and blue before and after discoloration was large.

### COMPARATIVE EXAMPLE 13

The pigments were mixed at the average dispersed diameters and the formulations shown in FIG. 4. The order of the relationship in magnitude of the average dispersed diameters of the yellow pigment, the magenta pigment and the cyan pigment was set different order from the prescribed order. The toners were produced in the same manner as in Example 1 and evaluated in the same manner as in Example 1. While the chroma saturation before discoloration was good for the three colors, the discoloration rates of yellow and magenta were larger than that of cyan, and the change in hue of blue and green before and after discoloration was large.

### COMPARATIVE EXAMPLE 14

The pigments were mixed at the average dispersed diameters and the formulations shown in FIG. 4. The order of the relationship in magnitude of the average dispersed diameters of the yellow pigment, the magenta pigment and the cyan pigment was set different order from the prescribed order. The toners were produced in the same manner as in Example 1 and evaluated in the same manner as in Example 1. While the chroma saturation before discoloration was good for the three colors, the relationship of the discoloration rates was magenta>yellow>cyan, and the change in hue of red, blue and green before and after discoloration was large.

### EXAMPLE 15

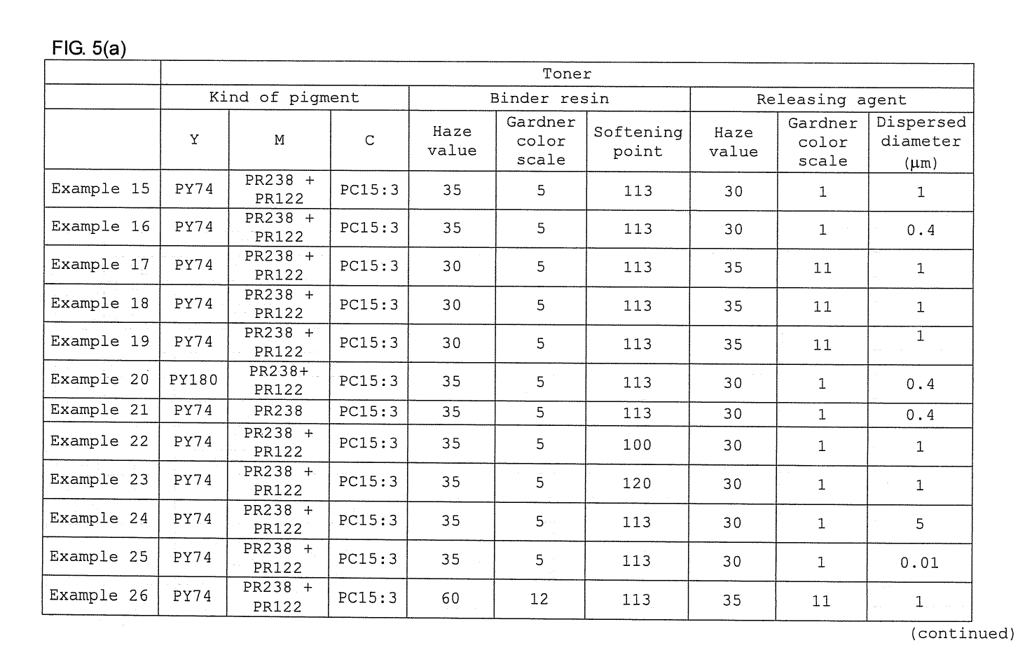

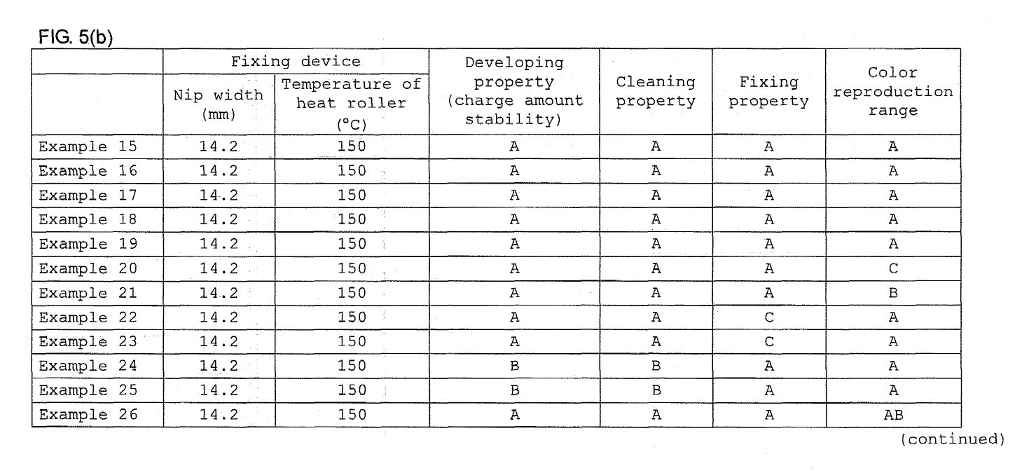

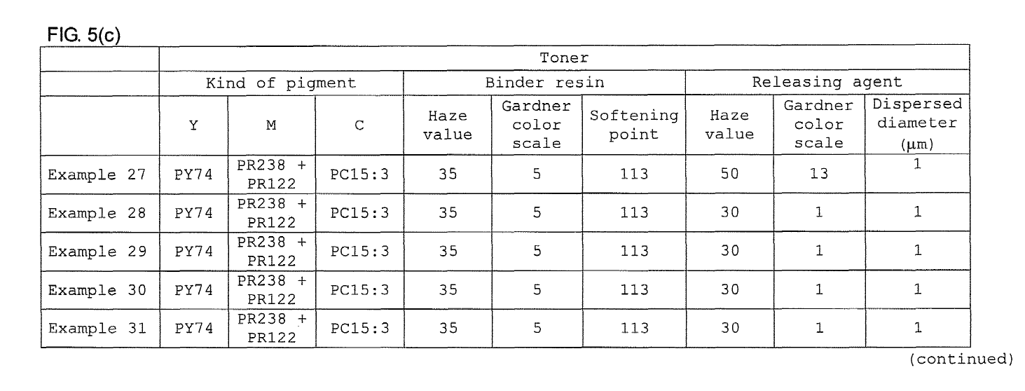

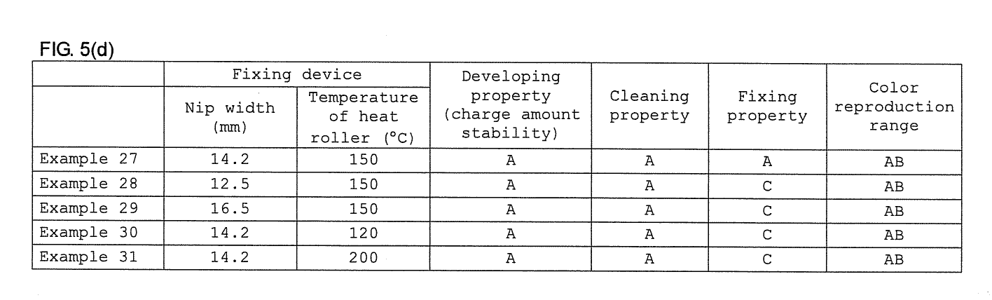

The pigments shown in FIG. 5 were used, and the average dispersed diameters of the yellow pigment, the magenta pigment and the cyan pigment were in the prescribed ranges and the order of the relationship in magnitude of the average dispersed diameters of the pigments was in the prescribed order. The pigments and the other components were mixed in the same manner as in Example 1, and toners were produced in the same manner as in Example 1. Developers were prepared by mixing the toners with a carrier to make a toner content of 7% by weight, and the developers were evaluated in the following manner using a multifunction printer e-STUDIO 3500C, produced by Toshiba Corporation, as an image forming apparatus.

### Evaluation of Developing Property (Charge Amount Stability)

A test chart having a print density of 8% was printed on 10,000 sheets of A4 size paper, and the image densities were measured for the first printed sheet and the 10,000th printed sheet by using a Macbeth densitometer Model 19I as a measuring apparatus. A difference between the image densities of less than 0.5 was evaluated as A (good), and that of 0.5 or more was evaluated as C (poor). A case where results A and C was given at least once in several times evaluation, was evaluated as B.

### Evaluation of Cleaning Property

A test chart having a print density of 8% was printed on 30,000 sheets of A4 size paper. A case where a photoreceptor cleaning blade failed to clean sufficiently to cause image failure was evaluated as C (poor), and a case where no image failure occurred was evaluated as A (good). A case where results A and C was given at least once in several times evaluation, was evaluated as B.

### Evaluation of Fixing Property

The amounts of the magenta toner and the cyan toner on the photoreceptor were adjusted to 0.3 mg/cm by controlling the developing voltages, and an image having three colors overlapping was output. A case where no fixing offset occurred was evaluated as A (good), and a case where fixing offset occurred was evaluated as C (poor).

### Evaluation of Color Reproduction Range

The chroma saturation was evaluated for blue, red and green in the following manners. A case where a value equal to or higher than the prescribed value was obtained for three colors was evaluated as A (good), and a case where a value lower than the prescribed value was obtained for at least one of three colors was evaluated as C (poor). A case where results A and C was given at least once in several times evaluation, was evaluated as B.

### 1. Evaluation of Blue Chroma Saturation Before Discoloration

The amounts of the magenta toner and the cyan toner on the photoreceptor were adjusted to 0.5 mg/cm by controlling the developing voltages, and an image having two colors overlapping was output. The chromatic coordinate thereof was measured. A square root of a sum of a* and b* of 47 or more was evaluated as A (good), and that of less than 47 was evaluated as C (poor).

### 2. Evaluation of Red Chroma Saturation Before Discoloration

The amounts of the magenta toner and the yellow toner were adjusted by controlling the developing voltages as similar to the evaluation of the blue chroma saturation before discoloration, and an image having two colors overlapping was output. The chromatic coordinate thereof was measured. A square root of a sum of a* and b* of 79 or more was evaluated as A (good), and that of less than 79 was evaluated as C (poor).

### 3. Evaluation of Green Chroma Saturation Before Discoloration

The amounts of the yellow toner and the cyan toner were adjusted by controlling the developing voltages as similar to the evaluation of the blue chroma saturation before discoloration, and an image having two colors overlapping was output. The chromatic coordinate thereof was measured. A square root of a sum of a* and b* of 63 or more was evaluated as A (good), and that of less than 63 was evaluated as C (poor).

The evaluation results are also shown in Table 5. As shown in FIG. 5, in Example 15, the binder resin had a haze value of 40 or less, a Gardner color scale of 7 or less and a softening point of 105 to 115° C., and the releasing agent had a haze value of 40 or less, a Gardner color scale of 11 or less and an average dispersed diameter of from 0.05 to 4 μm. The image forming apparatus had a nip width of the fixing device of from 13 to 16 mm and a temperature of the heat roller of 150° C. Satisfactory characteristics were obtained in developing property, cleaning property, fixing property and color reproduction ranges.

### EXAMPLE 16 TO 19

The pigments shown in FIG. 5 having average dispersed diameters set as similar to Example 15 were mixed in the same manner as in Example 1. The toners were produced in the same manner as in Example 1 and evaluated in the same manner as in Example 1. Satisfactory characteristics were obtained in all the evaluations as similar to Example 15.

### EXAMPLE 20

The pigments shown in FIG. 5 having average dispersed diameters set as similar to Example 15 were mixed in the same manner as in Example 1. The toners were produced in the same manner as in Example 1 and evaluated in the same manner as in Example 1. While no satisfactory result was obtained for color reproduction ranges since the yellow pigment did not contain a monoazo pigment PY 74, satisfactory characteristics were obtained in the other evaluations.

### EXAMPLE 21

The pigments shown in FIG. 5 having average dispersed diameters set as similar to Example 15 were mixed in the same manner as in Example 1. The toners were produced in the same manner as in Example 1 and evaluated in the same manner as in Example 1. While no satisfactory result was obtained for color reproduction ranges since the magenta pigment did not contain a quinacridone pigment PR 112, satisfactory characteristics were obtained in the other evaluations.

### EXAMPLE 22

The pigments shown in FIG. 5 having average dispersed diameters set as similar to Example 15 were mixed in the same manner as in Example 1. The toners were produced in the same manner as in Example 1 and evaluated in the same manner as in Example 1. While no satisfactory result was obtained for fixing property since the binder resin had a low softening point of 100° C., satisfactory characteristics were obtained in the other evaluations.

### EXAMPLE 23

The pigments shown in FIG. 5 having average dispersed diameters set as similar to Example 15 were mixed in the same manner as in Example 1. The toners were produced in the same manner as in Example 1 and evaluated in the same manner as in Example 1. While no satisfactory result was obtained for fixing property since the binder resin had a high softening point of 120° C., satisfactory characteristics were obtained in the other evaluations.

### EXAMPLE 24

The pigments shown in FIG. 5 having average dispersed diameters set as similar to Example 15 were mixed in the same manner as in Example 1. The toners were produced in the same manner as in Example 1 and evaluated in the same manner as in Example 1. While no satisfactory result was obtained for developing property and cleaning property since the releasing agent had a large dispersed diameter of 5 μm, satisfactory characteristics were obtained in the other evaluations.

### EXAMPLE 25

The pigments shown in FIG. 5 having average dispersed diameters set as similar to Example 15 were mixed in the same manner as in Example 1. The toners were produced in the same manner as in Example 1 and evaluated in the same manner as in Example 1. While no satisfactory result was obtained for developing property and cleaning property since the releasing agent had a small dispersed diameter of 0.01 μm, satisfactory characteristics were obtained in the other evaluations.

### EXAMPLE 26

The pigments shown in FIG. 5 having average dispersed diameters set as similar to Example 15 were mixed in the same manner as in Example 1. The toners were produced in the same manner as in Example 1 and evaluated in the same manner as in Example 1. While no satisfactory result was obtained for color reproducibility since the binder resin had a large Gardner color scale of 12, satisfactory characteristics were obtained in the other evaluations.

### EXAMPLE 27

The pigments shown in FIG. 5 having average dispersed diameters set as similar to Example 15 were mixed in the same manner as in Example 1. The toners were produced in the same manner as in Example 1 and evaluated in the same manner as in Example 1. While no satisfactory result was obtained for color reproducibility since the releasing agent had a large Gardner color scale of 13, satisfactory characteristics were obtained in the other evaluations.

### EXAMPLE 28

The pigments shown in FIG. 5 having average dispersed diameters set as similar to Example 15 were mixed in the same manner as in Example 1. The toners were produced in the same manner as in Example 1 and evaluated in the same manner as in Example 1. While no satisfactory result was obtained for fixing property and color reproducibility since the fixing device had a small nip width of 12.5 mm, satisfactory characteristics were obtained in the other evaluations.

### EXAMPLE 29

The pigments shown in FIG. 5 having average dispersed diameters set as similar to Example 15 were mixed in the same manner as in Example 1. The toners were produced in the same manner as in Example 1 and evaluated in the same manner as in Example 1. While no satisfactory result was obtained for fixing property and color reproducibility since the fixing device had a large nip width of 16.5 mm, satisfactory characteristics were obtained in the other evaluations.

### EXAMPLE 30

The pigments shown in FIG. 5 having average dispersed diameters set as similar to Example 15 were mixed in the same manner as in Example 1. The toners were produced in the same manner as in Example 1 and evaluated in the same manner as in Example 1. While no satisfactory result was obtained for fixing property and color reproducibility since the fixing device had a low temperature of the heat roller of 120° C., satisfactory characteristics were obtained in the other evaluations.

### EXAMPLE 31

The pigments shown in FIG. 5 having average dispersed diameters set as similar to Example 15 were mixed in the same manner as in Example 1. The toners were produced in the same manner as in Example 1 and evaluated in the same manner as in Example 1. While no satisfactory result was obtained for fixing property and color reproducibility since the fixing device had a high temperature of the heat roller of 200° C., satisfactory characteristics were obtained in the other evaluations.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A developer comprising:
a magenta pigment containing a pigment having an average dispersed diameter dₘ satisfying 0.1≦dₘ≦1.0 (μm) and containing a Cl group and a quinacridone pigment.

2. The developer according to claim 1, wherein a content of the quinacridone pigment is from 10 to 70% by weight based on the magenta pigment.

3. An image forming method comprising:
transferring toner images onto a transfer medium to form an image, the transferring toner images formed with a yellow toner, a magenta toner, a cyan toner and a black toner on an image carrying member,
wherein the yellow toner containing a yellow pigment having an average dispersed diameter d_{y} satisfying 0.05≦d_{y}≦0.50 (μm), a binder resin and a releasing agent,
the magenta toner containing a magenta pigment having an average dispersed diameter dₘ satisfying 0.1≦dₘ≦1.0 (μm), a binder resin and a releasing agent,
the cyan toner containing a cyan pigment having an average dispersed diameter d_{c} satisfying 0.03≦d_{c}≦0.3 (μm), a binder resin and a releasing agent, and
dₘ, d_{y} and d_{c} satisfying relationship dₘ>d_{y}>d_{c}.

4. The method according to claim 3, wherein the yellow pigment contains 70% by weight or more of a monoazo pigment.

5. The method according to claim 4, wherein the monoazo pigment contains Pigment Yellow 74.

6. The method according to claim 3, wherein the magenta pigment contains a pigment containing a Cl group and a quinacridone pigment.

7. The method according to claim 6, wherein a content of the quinacridone pigment is from 10 to 70% by weight based on the magenta pigment.

8. The method according to claim 6, wherein the quinacridone pigment contains Pigment Red 122.

9. The method according to claim 3, wherein the cyan pigment contains 90% by weight or more of a phthalocyanine pigment.

10. The method according to claim 9, wherein the phthalocyanine pigment contains Pigment Blue 15.

11. The method according to claim 3, wherein the yellow pigment contains 70% by weight or more of Pigment Yellow 74, the magenta pigment contains a pigment containing a Cl group and a Pigment Red 122, and the cyan pigment contains 90% by weight or more of Pigment Blue 15.

12. An image forming apparatus comprising:
an image carrying member to be formed toner images with toner particles containing a yellow toner, a magenta toner, a cyan toner and a black toner, the toner images formed with the toner particles on the image carrying member being transferred onto a transfer medium to form an image,
wherein the yellow toner containing a yellow pigment having an average dispersed diameter d_{y} satisfying 0.05≦d_{y}≦0.50 (μm), a binder resin and a releasing agent,
the magenta toner containing a magenta pigment having an average dispersed diameter dₘ satisfying 0.1≦dₘ≦1.0 (μm), a binder resin and a releasing agent,
the cyan toner containing a cyan pigment having an average dispersed diameter d_{c} satisfying 0.03≦d_{c}≦0.3 (μm), a binder resin and a releasing agent, and
dₘ, d_{y} and d_{c} satisfying relationship dₘ>d_{y}>d_{c}.

13. The apparatus according to claim 12, wherein the yellow pigment contains 70% by weight or more of a monoazo pigment.

14. The apparatus according to claim 13, wherein the monoazo pigment contains Pigment Yellow 74.

15. The apparatus according to claim 12, wherein the magenta pigment contains a pigment containing a Cl group and a quinacridone pigment.

16. The apparatus according to claim 15, wherein a content of the quinacridone pigment is from 10 to 70% by weight based on the magenta pigment.

17. The apparatus according to claim 15, wherein the quinacridone pigment contains Pigment Red 122.

18. The apparatus according to claim 12, wherein the cyan pigment contains 90% by weight or more of a phthalocyanine pigment.

19. The apparatus according to claim 18, wherein the phthalocyanine pigment contains Pigment Blue 15.

20. The apparatus according to claim 12, wherein the yellow pigment contains 70% by weight or more of Pigment Yellow 74, the magenta pigment contains a pigment containing a Cl group and a Pigment Red 122, and the cyan pigment contains 90% by weight or more of Pigment Blue 15.
